(19) United States
(12) Patent Application Publication
(10) Pub. No.: US 2015/0003002 A1
(43) Pub. Date: Jan. 1, 2015

(54) EXPANSION CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: MENG-LIANG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/974,148

(22) Filed: Aug. 23, 2013

(30) Foreign Application Priority Data
Jul. 1, 2013 (CN) 2013102712769

(51) Int. Cl. G06F 1/18

(52) U.S. Cl. CPC G06F 1/185
USPC 361/679.32

(57) ABSTRACT

An expansion card includes a control chip, memory storage chips, and solid state drive (SSD) storage chips connected to the control chip. A first edge connector is set on a bottom edge of the expansion card and engages in a memory slot. The first edge connector includes first power pins connected to the memory storage chips, the SSD storage chips, and the control chip, first ground pins grounded, and first signal pins connected to the memory storage chips. An extending board is extended from a side edge of the expansion card and coplanar with the circuit board. A second edge connector is arranged on the extending board and connected to a storage device interface. The second edge connector includes second ground pins grounded and second signal pins connected to the control chip.

### BACKGROUND

1. Technical Field

The present disclosure relates to an expansion card.

2. Description of Related Art

Many computing devices provide both data storage such as in the form of a hard drive and memory. Depending on need, some users prefer computing devices having relatively large storage capacity, others prefer the computer to have a relatively large memory capacity. In general, a plurality of memory slots may be built into the motherboard of a computing device, to receive memories and serial advanced technology attachment (SATA) dual in-line memory module (DIMM) devices, to satisfy the requirements of users' memory and storage needs. However, adding memory slots will occupy precious real estate on the motherboard. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an expansion card in accordance with an embodiment.

FIG. 2 is similar to FIG. 1, but viewed from another perspective.

FIG. 3 is a schematic view of the expansion card of FIG. 1 connected to a motherboard.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

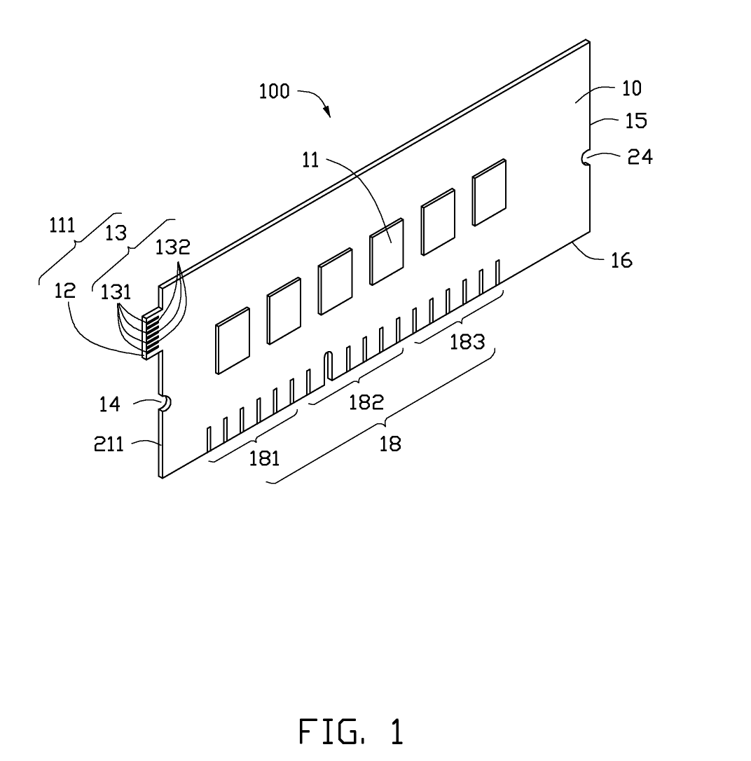

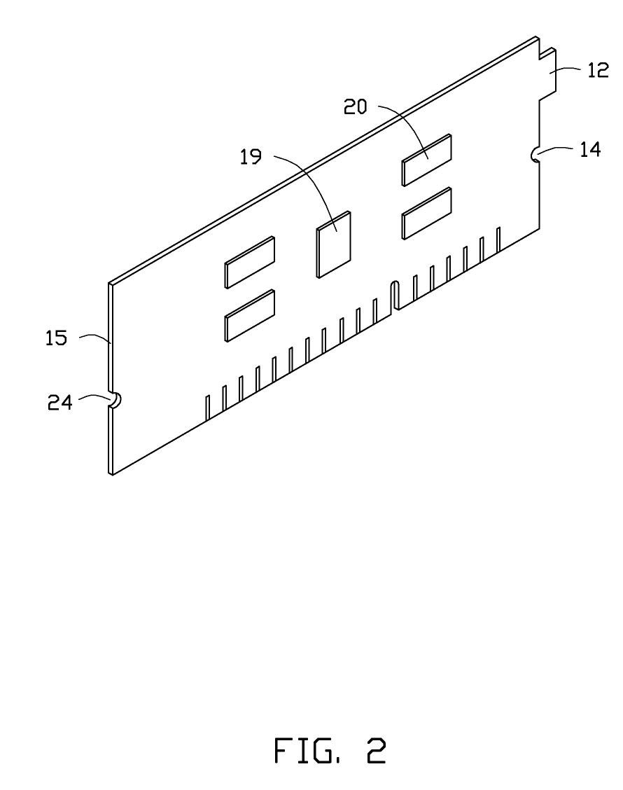

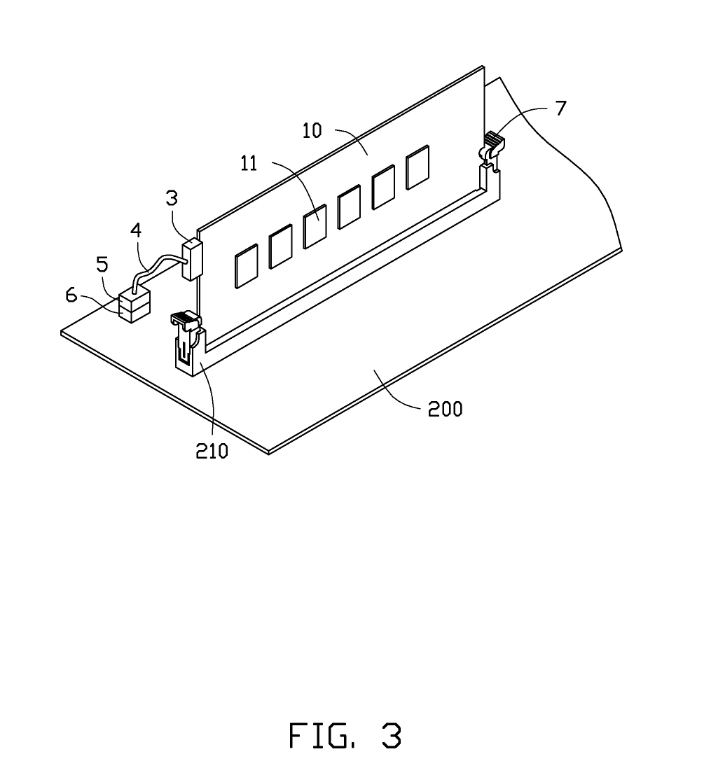

FIGS. 1 to 3 show an expansion card 100 in accordance with an embodiment. The expansion card 100 includes a substantially rectangular circuit board 10. A memory expansion unit is arranged on a first surface of the circuit board 10. The memory expansion unit includes a plurality of memory storage chips 11. A solid state drive (SSD) expansion unit is arranged on a second surface of the circuit board 10 opposite to the first surface. The SSD expansion unit includes a control chip 19 and a plurality of SSD storage chips 20 connected to the control chip 19. In one embodiment, the memory storage chips 11 are the same as the storage chips of known memory cards, such as read-only memory, random access memory, or high speed cache memory. The SSD storage chips 20 are the same as the storage chips of known SSDs, such as flash chips. An extending board 12 extends from a side edge 211 of the circuit board 10 and coplanar with the circuit board 10. An edge connector 13 is arranged on the extending board 12. The edge connector 13 and the extending board 12 compose a storage device connector 111. The edge connector 13 includes a plurality of signal pins 131 and a plurality of ground pins 132. The signal pins 131 include a pair of signal input pins and a pair of signal output pins. The ground pins 132 include three ground pins. The signal pins 131 are connected to the control chip 19. The ground pins 132 are connected to a ground layer (not shown) of the circuit board 10.

An edge connector 18 is arranged on a bottom edge 16 of the circuit board 10, to be inserted into a memory slot 210 of a motherboard 200. The edge connector 18 includes a plurality of power pins 181, a plurality of ground pins 182, and a plurality of signal pins 183. The power pins 181 are connected to the memory storage chips 11, the SSD storage chips 20, and the control chip 19, to provide voltages to the memory storage chips 11, the SSD storage chips 20, and the control chip 19. The ground pins 182 are connected to a ground layer (not shown) of the circuit board 10. The signal pins 183 are connected to the memory storage chips 11. A groove 14 is defined in the side edge 211 of the circuit board 10 and located under the extending board 12. Another groove 24 is defined in a side edge 15 of the circuit board 10 opposite to the side edge 211.

In one embodiment, the storage device connector 111 accords with serial advanced technology attachment (SATA) standard. In other embodiments, the storage device connector 111 can be arranged on other edges of the circuit board 10 as needed to connect to the motherboard 200 conveniently.

In use, the edge connector 18 is inserted into the memory slot 210 of the motherboard 200. Two fixing elements 7 of the memory slot 210 are engaged in the grooves 14 and 24, to fix the expansion card 100 to the memory slot 210. The storage device connector 111 is connected to a storage device interface 3. A storage device interface 5 is connected to the storage device interface 3 by a cable 4 and is directly connected to a storage device interface 6 of the motherboard 200.

When the motherboard 200 receives power, the motherboard 200 outputs voltages to the control chip 19, the memory storage chips 11, and the SSD storage chips 20 of the expansion card 100 through the memory slot 210 and the power pins 181 of the edge connector 18. At the same time, the motherboard 200 outputs a memory signal to the memory storage chips 11 through the memory slot 210 and the signal pins 183 of the edge connector 18, to control the memory storage chips 11 to read or write data. The motherboard 200 outputs an SSD signal to the control chip 19 of the expansion card 100 through the storage device interfaces 6 and 5, the cable 4, the storage device interface 3, and the edge connector 13 of the storage device connector 111. The control chip 19 controls the SSD storage chips 20 to read or write data according to the SSD signal.

The motherboard 200 outputs an SSD signal to the SSD expansion unit of the expansion card 100 through the storage device connector 111, and the motherboard 200 also outputs a memory signal to the memory expansion unit of the expansion card 100 through the memory slot 210 and the signal pins 183. Therefore, the motherboard 200 can satisfy the memory capacity requirement and the SSD capacity requirement through using the expansion card 100, while saving space on the motherboard 200.

Even though numerous characteristics and advantages of the disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. An expansion card, comprising:
a circuit board;
a control chip arranged on the circuit board;
a plurality of memory storage chips arranged on the circuit board;
a plurality of solid state drive (SSD) storage chips arranged on the circuit board and connected to the control chip;
a first edge connector set on a bottom edge of the circuit board and engaging in a memory slot of a motherboard, the first edge connector comprising a plurality of first power pins connected to the memory storage chips, the SSD storage chips, and the control chip, a plurality of first ground pins grounded, and a plurality of first signal pins connected to the plurality of memory storage chips; and
an extending board extended from a side edge of the circuit board and coplanar with the circuit board, wherein a second edge connector is arranged on the extending board and connected to a storage device interface of the motherboard, the second edge connector comprises a plurality of second ground pins grounded and a plurality of second signal pins connected to the control chip.

2. The expansion card of claim 1, wherein the extending board and the second edge connector compose a storage device connector, the storage device connector accords with serial advanced technology attachment (SATA) standard.

3. The expansion card of claim 1, wherein the plurality of second signal pins comprises a pair of signal input pins and a pair of signal output pins, the plurality of second ground pins comprises three ground pins.

4. The expansion card of claim 1, wherein the plurality of memory storage chips is arranged on a first surface of the circuit board, the control chip and the plurality of SSD storage chips are arranged on a second surface of the circuit board opposite to the first surface.
